(19) United States
(12) Patent Application Publication
(10) Pub. No.: US 2025/0257834 A1
(43) Pub. Date: Aug. 14, 2025

(54) CONNECTOR FOR CONNECTING A DUCT FOR CIRCULATING A FLUID TO A UTILITY AND RELATED FIXING SYSTEM

(71) Applicant: I.V.A.R. S.P.A., Prevalle (BS) (IT)

(72) Inventor: Umberto BERTOLOTTI, Prevalle (BS) (IT)

(73) Assignee: I.V.A.R. S.P.A., Prevalle (BS) (IT)

(21) Appl. No.: 18/856,680

(22) PCT Filed: Mar. 30, 2023
(86) PCT No.: PCT/IB2023/053198

§ 371 Date: Oct. 14, 2024

(30) Foreign Application Priority Data
Apr. 14, 2022 (IT) 102022000007499

(51) Int. Cl. F16L 39/04; F16L 43/02

(52) U.S. Cl. CPC F16L 39/04; F16L 43/02

(57) ABSTRACT

A connector for connecting a duct (for circulating a fluid to a utility includes a hollow body defining a channel for the passage of the fluid between a first opening and a second opening. The hollow body is configured for being constrained to the duct at the second opening. The connector comprises also an interface member associated to the hollow body at the first opening and configured for associating the connector to an anchorage structure. The interface member is also configured for connecting the connector to the utility and for allowing a fluid communication between the channel and the utility. The connector provides that the hollow body and the interface member are, during use, freely rotating in a reciprocating manner around a rotation axis.

### FIELD OF THE INVENTION

The present invention has as its object a connector for connecting a duct for circulating a fluid to a utility, for example a connector for connecting a duct in a hydraulic system for circulating a fluid, typically water, to or from a device for using said fluid. Specifically, the connector object of the present invention is intended to connect a utility, located on one side of a wall or analogous dividing element, with a duct for circulating a fluid, typically a flexible duct located on the opposite side of said wall or analogous dividing element. As an example, the connector object of the present invention finds particular application in the context of the installation of sanitary facilities, e.g., wall-mounted faucets, both in residential and in commercial and/or industrial settings.

The present invention has also as its object a mounting system comprising said connector and a related installation method. Said mounting system is configured for allowing the installation of a utility at a wall, or analogous dividing element, and the connection of this utility to a duct for circulating a fluid, for example a flexible duct in a hydraulic system.

### STATE OF THE ART

In the context of the installation of sanitary facilities, it is necessary to connect a utility to a duct of a system for circulating fluids, generally a hydraulic system for circulating water. Hydraulic system ducts typically extend below the floor of the rooms they are to serve and then end in a gap within the walls up to approximately the height at which a utility to be served is installed, e.g., a faucet or a coupling for the connection of elements, such as additional ducts, adapted to serve said utility. The connected utility is arranged outside of the wall so as to serve the user who needs the related service. A typical example of utility served by the water system is constituted by wall-mounted faucets, possibly served by two ducts, one for the cold water and one for the hot water, and provided with related mixers for adjusting the served water temperature. Still another example is constituted by household appliances, such as washing machine or dishwasher, which require water loading and unloading operations to carry out the relevant washing actions.

In order to connect the utilities to the hydraulic system, it is necessary to cross the walls that define the room within which the utility is installed. In particular, it is necessary to make at least one opening in the wall to allow the supply/unloading duct to exit from the gap in which the duct itself is housed. However, the free end of the supply/unloading duct is not typically connected to the utility to be served, but rather an interface connector is interposed that, in addition to allowing the interconnection between the duct and the utility, is configured for fixing the duct itself to the wall and for allowing the subsequent installation of the utility.

At the present time, the most used interface devices consist of systems comprising a connector, typically an elbow connector, and a fixing plate to the wall. Once the duct passage opening is drilled, the fixing plate is anchored, typically through the use of screws, to the wall at the opening itself. The free end of the duct is then connected to a respective connector end. Depending on the design choices and the typology of supply duct, the connector can be either a pressing connector (also said screw connector) or a tightening connector (also said clamping connector). Finally, the opposite end of the connector is anchored, typically through additional screws, to the fixing plate so that the supply duct and the remaining part of the connector are housed in the wall gap. At this point the utility can be connected to the other end of the connector at the fixing plate.

These typologies of interfaces are particularly appreciated because they ensure an integral and stable fixing between the fixing plate and the connector, facilitating the subsequent operations of connecting the utility to the connector itself, and thus to the fluid supply duct. In fact, the connection of the utility to the connector is typically done by screwing, and should the connector be movable with respect to the fixing plate, such operations would be more laborious due to the contextual rotation of the connector. Furthermore, by rotating with respect to the plate, the connector would also rotate the supply duct, which, by moving within the gap, could damage or compromise the fixing between the connector and the duct itself.

However, due to the many fixing and screwing operations required, the use of such systems for connecting utilities to fluid supply ducts is not free from drawbacks, and in particular it is complex and requires long time frames.

In order to overcome these drawbacks, the document ITUB201645162U1 describes a device for connecting faucets to a wall by means of a connector-fixing-plate system that does not require the use of screws for fixing the connector to the plate. On the one hand, such a system provides that the fixing plate is provided with one or more seats defined between stoppers protruding from the predominantly planar extension of the plate. On the other hand, the front portion (i.e., the one on the utility side) of the connector of ITUB201645162U1 is provided with one or more teeth, adapted to be housed within the related seats of the plate. Once the plate is anchored to the wall and the duct is fixed to the connector, the connector is connected to the plate by inserting the teeth of the front portion of the connector inside the seats of the plate so as to realize a mechanical anti-rotation coupling. In order to complete the mounting, it is necessary to apply a ring nut on the front (threaded) end of the connector, which protrudes frontally from the hole of the plate once the connector has been anchored to the plate itself; the ring nut then is on the front face of the plate, facing the utility to be connected to the connector (typically a wall-mounted faucet).

Although it solves part of the problems of known connector-fixing plate systems, the device of ITUB201645162U1 has in turn some drawbacks.

First, the mechanical coupling between teeth and seats results unstable, and there is a possibility that the connector will detach from the plate simply by applying even a small tensile or shear force.

Furthermore, the system of ITUB201645162U1 allows a limited number of configurations, corresponding to the relevant positionings of the connector with respect to the plate. Different relevant positionings correspond to different angular positions assumed by the connector with respect to the fixing plate, which by constitution, is fixed with respect to the wall. Specifically, the number of possible system configurations is determined by the number of seats in which the teeth of the front portion of the connector can be housed. The choice of configuration is determined by the orientation of the supply duct within the gap in the wall. For example, if the fluid supply duct extends perpendicularly to the floor approaching the opening in the wall from below, then a configuration is chosen such that the end of the connector to be connected to the duct also faces downward perpendicularly to the floor. It is therefore advantageous to choose the configuration of the plate-connector system according to the orientation of the duct so as to minimize the bending to which the latter is subjected and in order then to avoid bottlenecks and/or damages. Needless to say, being limited the number of configurations that can be assumed by the system, the system finds often itself operating under suboptimal conditions that subject the duct to a stress condition that in the long run can lead to damages, breakings and/or leakages. Furthermore, due to maintenance or renovation works, it may be necessary to move circulation ducts and even permanently change their orientation within the relevant gaps. In such situations, the above-described connector-plate systems will subject the circulation duct to a stressed condition unless arrangements are made to change the connector configuration, substantially repeating the installation operations.

In addition, the system of ITUB201645162U1 has a complex conformation (observe, for example, the stoppers protruding from the plate holes and the connector teeth) and a laborious mounting.

### OBJECT OF THE INVENTION

Thus, the general purpose of the present invention is to solve at least one of the drawbacks and/or limitations of the previous solutions.

One purpose of the invention is to provide a connector for connecting a utility to a circulation duct of a fluid that allows an optimal coupling with any arrangement of the circulation duct in the wall gap in which it is housed. In particular, the connector according to the present invention allows to minimize the stress to which the circulation duct is subjected by decreasing or eliminating the stresses to which both the connector and the circulation duct are subjected due to a suboptimal mutual positioning.

It is also purpose of the present invention to provide a connector for connecting a utility to a circulation duct that is easy to couple, on the one hand, to the circulation duct and, on the other hand, to the utility to be served.

A further purpose of the present invention is to provide a mounting system of said connector to a wall, particularly to a plasterboard wall or an analogous dividing element. Specifically, the mounting system according to the present invention allows for a stable coupling between its components, at least as stable as the one of known solutions requiring screws for fixing the connector to the mounting plate, but with particularly simplified and rapid installation.

Another purpose of the present invention is to provide an installation method of said fixing system that is particularly simplified and rapid to carry out.

It is then a purpose of the present invention to provide a connector and system for connecting a utility to a circulation duct presenting a high degree of reliability and requiring a small number of maintenance operations. Another purpose of the present invention is to propose a connector and a system for connecting a utility to a circulation duct characterized by a simple and rational structure.

Further purpose of the present invention is to create alternative solutions, with respect to the known technique, in the realization of connectors and systems for connecting a utility to a circulation duct, and/or to open new design fields.

These purposes, and any others, which will better result during the following description, are substantially achieved by a connector, a mounting system comprising said connector and a related installation method according to one or more of the attached claims, each of them considered alone (without the related dependent claims) or in any combination with the other claims, as well as according to the following aspects and/or embodiments, variously combined, also with said claims.

### SUMMARY

According to a first aspect, the present invention concerns a connector. Specifically, the present invention concerns a connector for connecting a duct for circulating a fluid, typically water, to a utility.

In the present document, with the term “utility” is intended any device adapted to receive and/or discharge a fluid to supply a service. Typical examples of utilities using a fluid to supply a service are represented by faucets, for example in the context of sanitary facilities, or by household appliances, such as washing machines and dishwashers that use a fluid for cleaning operations. The above-mentioned examples use a fluid to supply a service, which, in the case of faucets, is represented by the simple distribution of water, possibly at a desired temperature after mixing cold water and hot water.

According to the above, with the expression “duct for circulating a fluid” is intended a pipeline within the context of a fluid circulation system. For example, said circulation system may coincide with a hydraulic system connected to a residential and/or commercial-type environment. Depending on the applications, the circulation duct may be a supply duct, adapted to bring a fluid into said utility, or a discharge duct, adapted to collect a fluid out of said utility.

Without loss of generality, reference will be made in the present document to a water circulation duct in the context of the hydraulic system configured for serving a residential and/or commercial-type environment. Said duct is generally a flexible duct housed in a gap formed in a wall, such as a plasterboard wall or analogous dividing element, defining the environment in which the utility is to be installed. Specifically, the present invention is well suited for being applied in the context of connecting a utility at a plasterboard wall. Typically, water circulation ducts in the context of a hydraulic system are multilayer type ducts, e.g., M-pipes type ducts comprising at least one metal layer enclosed between multiple polymer layers. Such typology of ducts lends itself well to the circulation of pressurized water. It is therefore understood that the connection connector according to the present invention can be used in contexts where the fluid circulating in the duct is other than water.

According to one aspect, the connector comprises a hollow body. Said hollow body defines a channel for the passage of said fluid between a first opening and at least one second opening. Depending on the number of second openings present, said hollow body defines a multi-path channel adapted to connect each second opening to said first opening and allow fluid to flow between said openings. It is noted that the channel defined by the hollow body is not one-way and the fluid flow within it can extend in both the directions, both from said first opening to said at least one second opening and vice versa. In some embodiments, the connector may comprise flow intercepting elements associated with the channel, such as valves or diverters, in order to condition the fluid flow within the channel itself.

Said hollow body is configured for being constrained to said fluid circulation duct at said at least one second opening. As will become clearer hereinafter, the constraint between the fluid circulation duct and the second opening occurs with known techniques adapted to maintain the stable contact between the hollow body and the duct so as to prevent accidental detachment.

According to another aspect, the connector comprises an interface member. Said interface member is associated with said hollow body substantially at said first opening. Specifically, the interface member is mounted on said hollow body at a relevant portion of the end in which the first opening is formed.

According to one aspect, the interface member is configured for associating said connector to an anchorage structure. As will become clearer hereinafter from the present description, the anchorage structure is in charge of connecting the connector to a wall, such as a plasterboard wall or analogous dividing element, in which the housing gap of the fluid circulation duct to be constrained to the connector is obtained. In other words, the connector is not directly fixed to a wall, but rather it is stable in position by means of the interposition of the anchorage structure, which allows the mounting of the connector to said wall.

According to another aspect, the interface member is configured for connecting said connector to said utility. Specifically, the interface member is configured for allowing a fluid communication between said channel of the hollow body and said utility. It is noted that the utility can be directly connected to said connector at said interface member or the utility can be indirectly connected to said connector, for example by means of another duct connecting the utility to the connector. In fact, the interface member is configured as a flange adapted to connect and put in fluid communication the channel obtained in the hollow body and the utility.

According to another aspect, the hollow body and the interface member are, during use, freely rotating in a reciprocating manner around a rotation axis. In other words, the interface member is associated with said hollow body in such a way that a free rotation around said rotation axis is possible between said interface member and hollow body. In other words, said hollow body and said interface member are not integral to each other, but said hollow body can rotate with respect to said interface member around said rotation axis. In particular, when said connector is fixed to said wall by means of the anchorage structure, said interface member is stably connected to said anchorage structure, whereas said hollow body is free to rotate with respect to said interface member around said rotation axis.

Generally, with the expression “freely rotating” it is intended that the hollow body and the interface member are movably mounted to each other in such a way as to realize a connection/constrain that allows the mutual rotation around said rotation axis, preferably without the possibility of translation along said rotation axis. In other words, the hollow body and the interface member are mutually mounted such as there is only one degree of freedom in rotation (around said rotation axis) between them, whereas the remaining degrees of freedom in rotation and translation are preferably locked. Substantially, the hollow body and the interface member are mounted in such a way as to realize a joint/constrain that allows the mutual rotation around said rotation axis, in particular of the portion of the hollow body comprising the first opening with respect to the first seat of the interface member. According to a non-limiting aspect, the hollow body comprises a first opening and a single second opening. In this embodiment, the channel is a simple two-way channel extending between the first and the second opening for fluid circulation in at least one of the two directions between said first and second opening.

According to a non-limiting aspect, said hollow body comprises a first section, extended from said first opening along said rotation axis. In particular, said first section represents the association portion between the hollow body and the interface member. Furthermore, the first section acts as rotation shaft around which the mutual rotation between said interface member and said hollow body extends.

According to yet another aspect, the hollow body comprises at least one second section extended from said second opening along a direction not parallel to said rotation axis. According to this aspect, the hollow body does not define a straight channel between said first opening and at least one second opening, but rather a channel comprising at least one curvilinear or angled connecting section between said first section and second section.

According to another aspect, said first and second section extend in continuity with each other to substantially define the entire channel of the hollow body. In other words, said channel consists of two portions angled to each other to form a curved or bent channel.

According to a further non-limiting aspect, said connector is an elbow connector and said second section is extended in a direction substantially orthogonal to said rotation axis. Specifically, said first and second section are in continuity with each other and are mutually arranged to form a substantially right angle, i.e., to form a substantially “L”-shaped structure.

According to yet another non-limiting aspect, said interface member comprises first connection means to said anchorage structure. As it will be explained hereinafter, said first connection means are configured, during use, for maintaining a stable association between said interface member and said anchorage structure and for allowing the mounting of the connector on the anchorage structure.

According to a non-limiting aspect, said first connection means comprise a thread at an external surface of said interface member adapted to contact the anchorage structure. In particular, said thread is configured for cooperating with a corresponding thread present on the anchorage structure and enabling the stable association between the interface member of the connector and the anchorage structure.

According to another alternative and non-limiting aspect, said first connection means are configured for associating said connector to said anchorage structure by means of at least one among the following coupling types:
shaping coupling;
fitting coupling;
coupling via parts interference.

By way of example, said first connection means may comprise one or more protuberances—or teeth—adapted to couple with corresponding seats—or grooves—of the anchorage structure to ensure the stable association between the interface member of the connector and the anchorage structure. Alternatively, said first connection means may comprise one or more seats—or grooves—adapted to couple with corresponding protuberances—or teeth—of the anchorage structure to ensure the stable association between the interface member of the connector and the anchorage structure.

According to another non-limiting aspect, the interface member comprises:
a first seat configured for housing at least one portion of said hollow body comprising said first opening;
a second seat configured for connecting said utility;
a passage between said first seat and said second seat.

Specifically, said passage is configured for putting in fluid communication said first seat and said second seat so as to allow, during use, the fluid flow between said first opening and said utility. In other words, the passage is configured for allowing the fluid exchange between the channel of the hollow body, whose first opening is housed in said first seat, and the utility, which is connected at said second seat. The passage is, therefore, configured for allowing the fluid flow from said hollow body to said utility and/or vice versa.

According to another non-limiting aspect, the first seat, the passage and the second seat are in continuity with each other and are substantially coaxially aligned along the entire extension of the interface member. Preferably, the first seat, the passage, and the second seat extend in continuity with each other along the entire extension of the interface member along the rotation axis.

According to another non-limiting aspect, said hollow body has, on an external surface thereof, an enlargement substantially at said first opening. Said enlargement is configured for being housed in said first seat. Specifically, said enlargement represents a portion of the hollow body with an enlarged section with respect to the remaining portion of the hollow body itself. Said enlargement is preferably positioned at said first section. In other words, at said first section, the hollow body has a shoulder adapted to break the extension of the external surface of said first section and generate said enlargement, which is intended to be housed within the first seat of the interface member.

According to another non-limiting aspect, said enlargement has a conformation mirroring the one of the first seat. Typically, said first seat comprises a cavity of substantially cylindrical or frustoconical form. Consequently, also the enlargement has a substantially cylindrical or frustoconical conformation mirroring the one of the first seat.

According to a further non-limiting aspect, said first seat of the interface member has at least one riveted end portion toward the rotation axis in a direction substantially perpendicular to said rotation axis. Specifically, said riveted end portion is configured for narrowing an access to said first seat. In other words, the end portion of the interface member results, during use, pliable toward the rotation axis in a direction substantially perpendicular to said rotation axis so as to define at least part of said first seat. Thus, as it will become clearer hereinafter, the access to said first seat is restricted and it is prevented the leakage of said enlargement from said first seat. Preferably, said enlargement has on an external surface thereof one or more grooves for housing at least one sealing gasket, for example an O-ring gasket, adapted to adhere to the internal surface of said first seat to prevent leakage of fluid.

According to another aspect, the interface member is associated with said hollow body via parts interference. Said association via parts interference is configured for limiting, preferably preventing, the mutual translation between said hollow body and said interface member along the rotation axis. In particular, when the enlargement is housed in said first seat, said enlargement is blocked within said first seat itself due to the presence of the riveted end portion. Specifically, the riveted end portion narrows the access to said first seat so as to prevent the undesired leakage of the enlargement from the first seat and the detachment of said hollow body from the interface member.

In the manufacturing operations of said connector, the hollow body is associated with the interface member by inserting the enlargement inside said first seat. Subsequently, the end portion of said interface member undergoes a plastic deformation, in particular a fold toward the rotation axis, which causes a narrowing of the access through which the enlargement was housed within the first seat. The narrowing of the section of said access is such that the enlargement is kept caged within said seat. An anti-slip coupling is thus generated between said hollow body and said interface member such that the mutual translation is limited, or substantially prevented, at least along the rotation axis, while freedom of rotation around the rotation axis itself is maintained. Substantially, a hinge-type mutual constraint is created between hollow body and interface member such that the translation is substantially prevented but freedom of rotation around the rotation axis is maintained. According to an alternative aspect, in another embodiment, said hollow body may have, at said first section, at least one groove adapted, during use, to be affected by said riveted portion in order to prevent the detachment between said hollow body and said interface member.

According to a non-limiting aspect, the passage of the interface member is in a direction substantially parallel, preferably coinciding, to said rotation axis. In other words, said passage is configured as a continuation of said first section of the channel defined by the hollow body. Said passage and said channel are in fluid communication at said first opening, which is housed in the first seat of the interface member.

According to another non-limiting aspect, said passage has, at least partially, a polygonal section in a plane perpendicular to said rotation axis. In particular, said passage is couplable to an instrument configured for acting on the interface member in order to associate it with said anchorage structure. This instrument has a head adapted to couple with said passage in order to manipulate said interface member so as to allow the coupling thereof with said anchorage structure. For example, once said head is inserted into said passage, the instrument is configured for rotating the interface member so as to screw it in and associate it with said anchorage structure.

According to yet another non-limiting aspect, said passage has hexagonal section in a plane perpendicular to said rotation axis in order to be affected by a hexagonal wrench or equivalent tool. For example, once the hexagonal wrench is inserted into said passage, it is possible to screw the interface member and associate the connector with the anchorage structure.

According to another non-limiting aspect, said second seat of the interface member comprises second connection means configured for connecting said utility to said connector. As previously indicated, the utility may be directly connected to the connector at said second means, as it occurs, for example, with wall-mounted faucets, or an additional connection duct may be interposed between the connector and the utility, as in the case of loading and/or unloading ducts of washing machines and dishwashers.

According to another non-limiting aspect, said second connection means comprise a thread at a portion of said second seat adapted to at least partially contact said utility or an additional connection duct connected thereto. According to yet another alternative and non-limiting aspect, said second connection means are configured for associating said connector with said utility by means of at least one among the following coupling types:
shaping coupling;
fitting coupling;
coupling via parts interference.

By way of example, said second connection means may comprise one or more protuberances—or teeth—adapted to couple with corresponding seats—or grooves—of the utility, or of the additional connection duct associated therewith, to ensure the stable association between the interface member of the connector and the utility itself. Alternatively, said second connection means may comprise one or more seats—or grooves—adapted to couple with corresponding protuberances-or teeth-of the utility or of the additional connection duct associated therewith.

According to another aspect, the connector comprises a constraint member. This constraint member is associable with said hollow body substantially at said second opening. In particular, said constraint member is associable with the second section of said hollow body. The constraint member is configured for constraining said connector and said fluid circulation duct together, more specifically said hollow body and said duct. It is noted that, unlike the association between hollow body and interface member, said hollow body and said constraint member are, during use, constrained to each other without substantial freedom of translation and rotation so as to keep the duct firmly constrained to the connector.

According to another non-limiting aspect, when associated with said hollow body, said constraint member defines with said hollow body a housing space for said duct around said hollow body. In particular, said constraint member is fit on said hollow body at a distance therefrom so as to define said housing space for the insertion of said duct. Specifically, the constraint member is configured for being deformed when said duct is inserted into said housing space so as to constrain said duct to said connector.

It is noted that the typology of constraint between said duct and connector is advantageously chosen depending on the typology of the duct to be connected. As previously mentioned, typically, said fluid circulation duct is a multilayer type duct, for example, a multilayer M-pipe type duct comprising at least one metal layer enclosed between multiple polymer layers.

According to an embodiment, said constraint member is configured for connecting said connector to said duct by means of a pressing connection. In this embodiment, the constraint member can be configured as a sleeve fit around said hollow body substantially at said second opening. This typology of connection is particularly adapted to multilayer type ducts. In fact, once the multilayer duct is inserted into the housing space, the sleeve representing the constraint member is plastically deformed by means of appropriate crimping pliers. In this way, the duct is compressed between the sleeve and the hollow body, which preferably comprises appropriate grooves, possibly housing O-ring type gaskets, adapted to improve the stability of the constraint. It is thus ensured the stable constraint between connector and duct.

According to another embodiment, said constraint member is configured for connecting said connector to said duct by means of a screw connection. In this embodiment, the constraint member may simply comprise a hose clamp or a nut and washer system in order to maintain the constraint between hollow body and duct.

In an independent aspect thereof, the present invention relates to a fixing system for connecting said duct for circulating a fluid to said utility. According to said aspect, the fixing system comprises:
at least one connector according to what has been previously described;
an anchorage structure for fixing said at least one connector to a wall.

According to an aspect, said anchorage structure is configured for being associated with a wall, for example a plasterboard wall or analogous dividing element, at at least one hole drilled in the wall itself. Specifically, said at least one hole is configured as an opening drilled in said wall in order to extract the duct for circulating a fluid, which results housed in a gap obtained in a thickness of the wall itself.

According to another aspect, the at least a connector is configured for being connected to said anchorage structure. In other words, the anchorage structure represents the means of fixing of the at least one connector to the wall.

Specifically, the at least one connector and the anchorage structure are, during use, connected at said interface member, which traverses at least partially said at least one hole. In other words, said interface member is, during use, attached to said anchorage structure and traverses at least partially the wall; consequently, the relevant hollow body is free to rotate relatively to the interface member around the rotation axis from a side of the wall opposite to the one where the utility is located.

According to a non-limiting aspect, with reference to the position assumed in the context of the fixing system, said interface member comprises:
a penetration portion extending substantially along said rotation axis and configured, during use, for at least partially traversing said wall at said at least one hole;
an abutment portion in axial continuity with said penetration portion and configured, during use, for being arranged outside said at least one hole in contact with said anchorage structure or said wall.

Specifically, said abutment portion is configured for being positioned externally to said hole from one side of the wall facing the utility. On the contrary, the hollow body is arranged, during use, internally to said wall, i.e., in said gap in which the duct for circulating a fluid is housed. In this sense, the abutment portion also represents an end stroke stop for the insertion of said penetration portion in the relevant hole in the wall.

According to a non-limiting aspect, said penetration portion has a substantially cylindrical form. In other words, the interface member has a substantially cylindrical conformation ending at one end with the abutment portion and at an opposite end with the riveted end portion.

According to an alternative non-limiting aspect, said penetration portion has a substantially frustoconical form. In other words, the interface member has a substantially frustoconical conformation ending at one end with the abutment portion and at an opposite end with the riveted end portion. Typically, the abutment portion is positioned in continuity with said penetration portion at the portion having the maximum diameter. Similarly, the riveted end portion is positioned in continuity with said penetration portion at the portion having the minimum diameter.

According to another non-limiting aspect, said abutment portion has a substantially flat extension. According to said aspect, the abutment portion is arranged in contact with said wall or said anchorage structure remaining substantially flush with said wall/anchorage structure or emerging from said wall/anchorage structure for a negligible thickness.

According to another non-limiting aspect, said anchorage structure comprises a connection portion for each connector comprised in the fixing system. Said connection portion is configured, in use, for being arranged in said hole. The connection portion is further configured for being connected to said interface member in order to associate said anchorage structure and said connector. In particular, said connection portion is configured for being connected to said penetration portion of the interface member. In fact, the connection portion of the anchorage structure acts as a plug—or fischer—for the fixing to the wall of at least one connector by means of the relevant interface member. In the mounting operations, in fact, the anchorage structure is first positioned by placing the connection member inside the hole, and then the connector is inserted, associating the interface member with the relevant connection portion of the anchorage structure.

According to yet another non-limiting aspect, said connection portion has a substantially cylindrical form. In the embodiments in which the penetration portion of the interface member has a cylindrical form, the connection portion has a substantially coinciding diameter so that it can house at least partially the interface member by adhering to the penetration portion. In the embodiments in which the penetration portion of the interface member has a frustoconical form, the connection portion has a diameter substantially intermediate between the maximum value and the minimum value of the penetration portion so as to allow an easy initial insertion of the interface member and, after the progressive insertion of the penetration portion, a deformation of the connection portion adapted to improve the adhesion of the anchorage structure to the wall. These aspects will become clearer hereinafter in the present description when the installation procedures of the fixing system are described. According to another non-limiting aspect, said connection portion comprises at least one notch, extended along at least part of a longitudinal extension of said connection portion. According to this aspect, the connection portion comprises at least a notch adapted to allow a deformation of the connection portion caused by the insertion of said interface member.

According to a further non-limiting aspect, said anchorage structure is a modular structure. According to this aspect, the anchorage structure comprises at least two modules comprising association means adapted to ensure a mutual association between the modules. Preferably, said at least two modules are adapted to be inserted into said hole and subsequently spaced out consequently to a deformation caused by the insertion of said interface member.

According to yet another non-limiting aspect, said connection portion comprises third connection means. These third connection means are configured for cooperating with said first connection means of said interface member in order to associate said anchorage structure and said connector.

According to another non-limiting aspect, said third connection means comprise at least one thread at an internal surface of said connection portion adapted to contact said interface member. In particular, in embodiments in which said first connection means comprise one thread, the relevant thread of said third connection means is configured for ensuring a connection between connection portion and interface member by means of screwing. According to another alternative and non-limiting aspect, said third connection means are configured for cooperating with said first connection means of the interface member in order to realize at least one among the following coupling types:
shaping coupling;
fitting coupling;
coupling via parts interference.

By way of example, said third connection means may comprise one or more protuberances—or teeth—adapted to couple with corresponding seats—or grooves—of the first connection means to ensure stable association between the connector interface member and the anchorage structure. Alternatively, said third connection means may comprise one or more seats—or grooves—adapted to couple with corresponding protuberances—or teeth—of the first connection means to ensure the stable association between the interface member of the connector and the anchorage structure.

It is noted that the connection between the interface member and the anchorage structure does not provide for the use of additional fixing means, such as screws, bolts or nuts. In this sense, the association between connector and anchorage structure, and therefore also the installation of the entire fixing system, is particularly fast and simplified with respect to known art solutions in which at least a portion of the connector needed to be fixed to the anchorage structure and/or to the wall by means of additional fixing means.

According to a further non-limiting aspect, said anchorage structure comprises a flat portion configured for adhering to said wall. In particular, the connection portion is protruding from said flat portion, which is in fact an end stroke stop for the insertion of said connection portion in the at least one hole drilled in the wall.

According to another non-limiting aspect, said flat portion comprises a plurality of seats for housing fixing means adapted to constrain the structure to the wall. In an embodiment, said plurality of seats comprises a plurality of through holes for the insertion of fixing means, such as screws, for the constraint of the anchorage structure to the wall, keeping the connection portion, or the connection portions, housed in the respective hole, or housed in the respective holes.

According to yet another non-limiting aspect, said anchorage structure comprises at least one stabilization element. Said at least one stabilization element is adapted, during use, to contact said wall, preferably internally to said at least one hole. In particular, said at least one stabilization element is configured for preventing the detachment of said anchorage structure from said wall.

According to a non-limiting aspect, said at least one stabilization element comprises at least one elastically pliable tab. Specifically, said at least one elastically pliable tab advantageously allows to stabilize the anchorage structure in installation operations, such as before the flat portion is fixed to the wall by means of said fixing means.

According to another non-limiting aspect, said at least one stabilization element comprises at least one rib emerging from said connection portion. Specifically, said at least one rib advantageously allows to stabilize and/or constrain the anchorage structure to the wall in installation operations. In fact, in the operations of insertion of the connection portion in the at least one hole, the at least one rib allows a prior adhesion of the connection portion to the surface defining the hole and, subsequent to a plastic deformation caused by the insertion of the interface member, a constraint of the anchorage structure to the wall, for example after a penetration of the at least one rib into the surface defining the hole.

In an independent aspect thereof, the present invention refers to an installation method of the fixing system for connecting a duct for circulating a fluid to a utility. This installation method comprises at least the following steps:
arranging a fixing system according to what has been previously described;
extracting at least one duct from at least one hole drilled in the wall;
positioning said anchorage structure at said at least one hole;
constraining said at least one duct to a corresponding connector at said second opening of the hollow body;
associating the connector to said anchorage structure by inserting said connector frontally with said anchorage structure.

It is noted that the above indicated steps do not need to be performed in the order of exposition. The above represents the typical installation sequence also followed for the installation of known fixing systems. However, depending on the different characteristics comprised in the different embodiments of the fixing system according to the present invention, some steps may be advanced or postponed from the above.

In addition, it is noted that when said anchorage structure is a modular structure comprising two or more modules, it is possible to perform the step of constraining the at least one duct to the corresponding connector without necessarily passing the at least one duct through the anchorage structure. In fact, classical anchorage structures have at least one perforated plate that must be passed through the duct before providing for constraining the duct to the connector. Should the duct be fixed to the connector before the positioning of the plate, it would be impossible to provide for a proper installation of the fixing system.

Some aspects of the steps of the installation method of the fixing system are now described in more detail. According to another non-limiting aspect, the step of extracting at least one duct involves that the at least one duct, initially housed in the gap of said wall, traverses a corresponding hole in order to be manipulated and subsequently associated to a corresponding connector. As such, where at least one hole is not already present in the wall, the installation method preferably comprises a preventive step of drilling at least one hole in said wall. This preventive step provides for making in said wall at least one through hole connecting the gap in which the duct for circulating a fluid is housed with the environment in which to place the utility to be served by said duct. Typically, said at least hole has a circular section and has a diameter sufficient to allow both the passage of said duct and the housing of the connection portion of the anchorage structure and of the interface member of the connector, particularly the penetration portion thereof. It is important that the at least one hole is appropriately sized in order to allow, on the one hand, the housing of the various components of the fixing system and, on the other hand, an effective grip of the anchorage structure that prevents the risk of detachment of the fixing system from the wall.

According to yet another non-limiting aspect, the step of positioning the anchorage structure at said at least one hole provides for housing at least partially each connection portion within a corresponding hole. In embodiments in which the anchorage structure does not have a modular structure, it is essential that the at least one duct is routed through the relevant connection portion before constraining it to the relevant connector, otherwise the installation method cannot be completed. On the contrary, if the anchorage structure has a modular structure, said step of positioning the anchorage structure at said at least one hole can be carried out after other operations, in particular before the step of constraining said at least one duct to the corresponding connector at said second opening of the hollow body. In some embodiments, the step of positioning the anchorage structure provides for fixing the anchorage structure itself to the wall by means of constraining means, such as screws. According to another non-limiting aspect, the step of constraining said at least one duct to the corresponding connector provides for fixing each duct to the relevant hollow body at said second opening in order to connect the channel of the hollow body with the duct for circulating. Preferably, said step of constraining said at least one duct to the corresponding connector provides for inserting each duct into the relevant housing space defined between the hollow body and the constraint member and, subsequently, associating each duct to the hollow body by means of a press connection or a screw connection, depending on the embodiment of the constraint member.

According to another non-limiting aspect, the step of associating each connector with said anchorage structure provides for inserting the penetration portion of the interface member in the connection portion of said anchorage structure, which preferably results already housed in said at least one hole. The cooperation between the first connection means and the third connection means allows a stable association between the anchorage structure and the interface member, and thus the connector. Thus, the interface member is stably connected to the anchorage structure whereas the hollow body is free to rotate around the rotation axis from the side of the wall facing the housing gap of the duct. Preferably, the step of associating each connector with said anchorage structure provides a screwing of said interface member. In particular, when said first and third connection means include threads, the screwing of the interface member allows the progressive insertion of the penetration portion into the connection portion and the constraint between connector and anchorage structure. It is also noted that, by virtue of the freedom of rotation between hollow body and interface member, the rotation of the latter does not result in the rotation of the entire connector, in particular of the hollow body, and the duct is not brought into rotation. Thus, during the operations of associating the connector with the anchorage structure, the relevant duct is stationed in a position that minimizes stresses and possible breakings, bottlenecks, and malfunctions due to undesired bending of the at least one duct are prevented.

According to another aspect, the step of associating the connector with the anchorage structure does not provide for the use of fixing means, such as screws. In fact, the anchorage structure and the connector are constrained to each other by means of the cooperation of the first connection means and the third connection means. In this view, the fixing of the connector to the anchorage structure is particularly facilitated.

According to another non-limiting aspect, once the fixing system is installed, the installation method comprises a final step of connecting said connector to said utility at second connection means of the second seat of the interface member. It is noted that the utility may be directly connected to said connector at said second seat or the utility can be indirectly connected to said connector, for example by means of another hose connecting the utility to the interface member of the connector.

### BRIEF DESCRIPTION OF DRAWINGS

Some embodiments and some aspects of the invention will be hereinafter described with reference to the attached drawings, provided for indicative purposes only and therefore non-limiting thereto wherein:

FIG. 1 is a perspective view of a connector for connecting a duct for circulating a fluid to a utility according to the present invention, according to a possible exemplificative embodiment;

FIG. 2 is a front view of the connector thereof in FIG. 1;

FIGS. 3 and 4 show two perspective views, respectively front and rear, of the fixing system object of the present invention according to a first exemplificative embodiment;

FIGS. 5 and 6 show two exploded views of the fixing system thereof in FIGS. 3 and 4 showing two steps of the related installation process;

FIGS. 7 and 8 show two perspective views, respectively front and rear, of a component of the fixing system of FIGS. 3 and 4;

FIG. 9 shows a sectional view according to the plane IX-IX of the fixing system of FIG. 3;

FIGS. 10 and 11 show two perspective views, respectively front and rear, of the fixing system object of the present invention according to a second exemplificative embodiment;

FIGS. 12 and 13 show two exploded views of the fixing system thereof in FIGS. 10 and 11 showing two steps of the related installation process;

FIG. 14 shows a perspective view of a component of the fixing system shown in FIGS. 10 and 11;

FIG. 15 shows an exploded view of the fixing system of FIGS. 10 and 11 with some hidden details for higher clarity;

FIG. 16 shows a sectional view according to the plane XVI-XVI of the fixing system of FIG. 10;

### DETAILED DESCRIPTION

It is noted that in the present description the corresponding parts shown in the various figures are indicated with the same numerical references. Figures could show the object of the invention through unscaled representations; therefore, parts and components shown in figures related to the object of the invention could refer exclusively to the schematic representations.

With reference to the attached figures it has been overall indicated with reference 1 a connector for connecting, hereinafter indicated for simplicity as connector 1. Specifically, the connector 1 is particularly adapted to the connection of a duct T1, T2, T for circulating a fluid to a utility.

In the present description, with the generic term “utility” is intended any device adapted to receive and/or discharge a fluid for supplying a service. Typical examples of utilities using a fluid to supply a service are represented by faucets, for example in the context of sanitary facilities, or by household appliances, such as washing machines and dishwashers that use a fluid for cleaning operations. The above-mentioned examples use a fluid to supply a service, which, in the case of faucets, is represented by the simple distribution of water, possibly at a desired temperature after mixing cold water and hot water.

According to the above, the term “duct for circulating a fluid” or simply “duct” refers to a pipeline within the context of a fluid circulation system. For example, said circulation system may coincide with a hydraulic system connected to a residential and/or commercial-type environment. Depending on the applications, the duct T1, T2, T may be a supply duct, adapted to bring a fluid into said utility, or a discharge duct, adapted to collect a fluid out of said utility.

Without loss of generality, specific reference will be made in the present description to a duct for circulating water T1, T2, T in the context of the hydraulic system configured for serving a residential and/or commercial-type environment. Said duct T1, T2, T is generally a flexible duct housed in a gap formed in a wall W, for example a plasterboard wall or an analogous dividing element, defining the environment in which the utility is to be installed. As it will become clearer hereinafter, the connector 1 is well suited to be used for connecting a utility at a plasterboard wall W.

Typically, ducts for circulating water T1, T2, T in the context of a hydraulic system are multi-layer type ducts, e.g. M-pipes type ducts comprising at least one metal layer enclosed between several polymer layers. This typology of ducts is well suited for the circulation of pressurized water. However, the connector 1 is also compatible with ducts of a different typology, also single-layer. Therefore, in the present description and in the attached figures is shown a generic duct T1, T2, T.

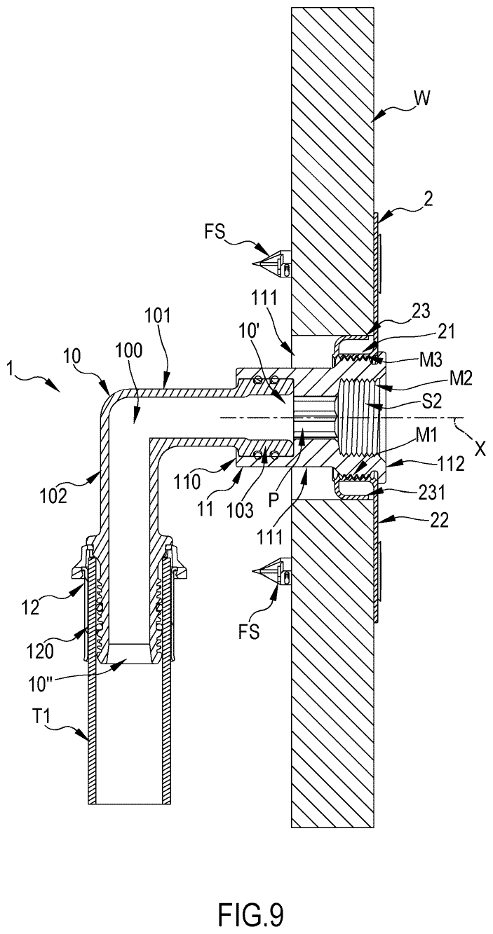

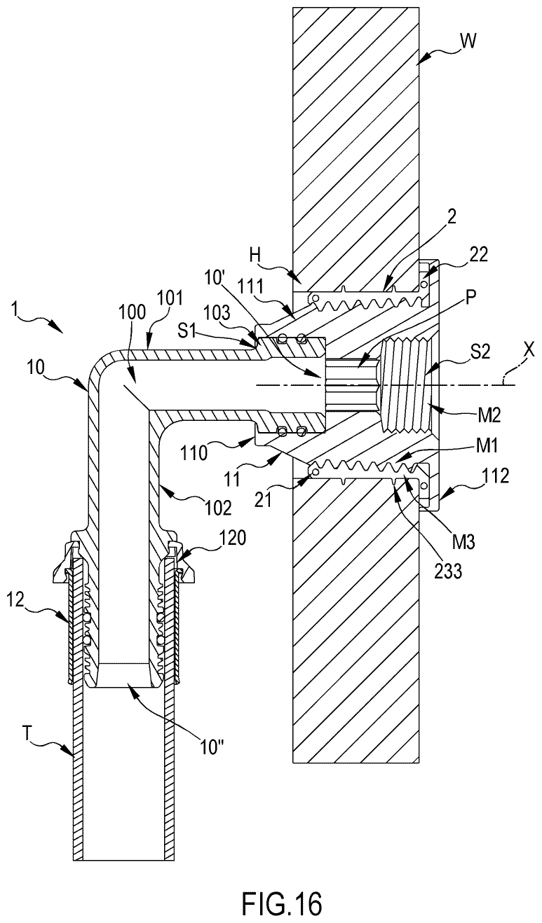

As shown in the attached figures and in particular in sections of FIGS. 9 and 16, the connector 1 comprises a hollow body 10. Said hollow body 10 defines a channel 100 for the passage of fluid between a first opening 10′ and at least one second opening 10″. Depending on the number of second openings 10″ present, said hollow body 10 defines a multi-path channel adapted to connect each second opening 10″ to said first opening 10′ and allow the fluid flow between said openings.

In the embodiments shown in the attached figures, the hollow body 10 comprises a first opening 10′ and a single second opening 10″. The channel 100 is then a simple two-way channel which extends between the first opening 10′ and the second opening 10″ for the circulation of fluid between said first and second opening. It is important to note that the channel 100 defined in the hollow body 10 is not a one-way channel. In other words, the fluid flow through the channel 100 may extend in both the directions, both from said first opening 10′ to said second opening 10″ and vice versa. In some embodiments not shown, the connector 1 may comprise flow intercepting elements associated with the channel 100, for example valves or diverters, in order to condition the fluid flow within the channel itself. Such intercepting elements may make the channel one-way by allowing the flow in one direction and blocking it in the opposite direction.

As shown, the hollow body 10 is configured for being constrained to said duct T1, T2, T at said second opening 10″. As will become clearer hereinafter, the constraint between the duct T1, T2, T and the second opening 10″ occurs with known techniques adapted to maintain the stable contact between the hollow body 10 and the duct T1, T2, T and to prevent the accidental detachment thereof.

The connector 1 also comprises an interface member 11. Said interface member 11 is associated with said hollow body 10 substantially at said first opening 10′. Specifically, the interface member 11 is mounted on said hollow body 10 at a relevant end portion in which is obtained the first opening 10′.

As shown in detail in sections of FIGS. 9 and 16, the interface member 11 is configured for associating said connector 1 to an anchorage structure. As it will be clearer hereinafter in the present description, the anchorage structure 2 is in charge of connecting the connector 1 to the wall W, for example a plasterboard wall or analogous dividing element, in which the housing gap of the duct T1, T2, T to be constrained to the connector 1 is obtained. In other words, the connector 1 is not directly fixed to the wall W, but rather it is stable in position by means of the interposition of the anchorage structure 2, which allows the mounting of the connector 1 to said wall W.

The interface member 11 is also configured for connecting said connector 1 to said utility. In particular, the interface member 11 is configured for allowing a fluid communication between said channel 100 of the hollow body 10 and said utility. It is noted that the utility can be directly connected to said connector at said interface member 11 or the utility can be indirectly connected to said connector 1, for example by means of another duct connecting the utility to the interface member 11. In fact, the interface member 11 is configured as a flange adapted to connect and putting in fluid communication the channel 100 and the utility.

During use, the hollow body 10 and interface member 11 are freely rotating in a reciprocating manner around a rotation axis X. In other words, the interface member 11 is associated with said hollow body 10 in such a way that a free rotation around said rotation axis X is possible between said interface member and hollow body. In other words, said hollow body 10 and said interface member 11 are not integral with each other, but said hollow body 10 can rotate relatively to said interface member 11 around said rotation axis X. In particular, when said connector 1 is fixed to said wall W by means of said anchorage structure 2, said interface member 11 is stably connected to said anchorage structure 2, whereas said hollow body 10 is free to rotate with respect to said interface member 11 around said rotation axis X.

In the shown embodiments, the hollow body 10 comprises at least one first section 101, extended from said first opening 10′ along said rotation axis X. As shown, said first section 101 represents the association portion between the hollow body 10 and the interface member 11 and acts, in fact, as a rotation shaft around which the mutual rotation between said interface member 11 and said hollow body 10 extends.

Furthermore, the hollow body 10 comprises a second section 102 extended from said second opening 10″ along a direction not parallel to said rotation axis X. Thus, the hollow body 10 does not define a straight channel 100 between said first opening 10′ and said second opening 10″, but rather it defines a channel 100 comprising at least one curvilinear or angled connecting section between said first section 101 and second section 102.

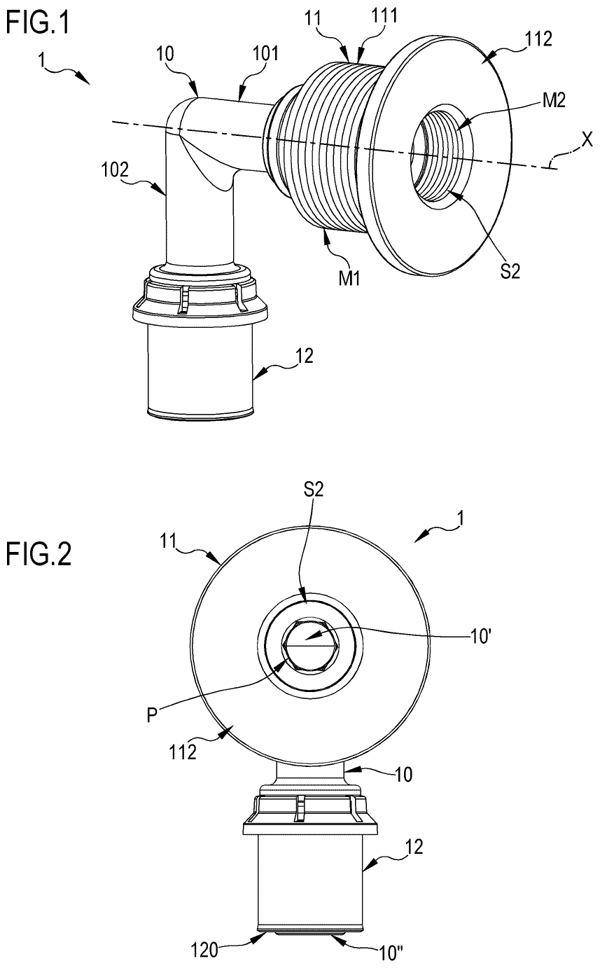

In the shown embodiments, said first section 101 and said second section 102 extend in continuity with each other to substantially define the entire channel 100 of the hollow body 10. In other words, said channel consists of two portions angled to each other to form a curved or bent channel 100. In particular, the connector 1 shown in the attached figures is an elbow connector and said second section 102 is extended in a direction substantially orthogonal to said rotation axis X. As already evident in FIG. 1, said first section 101 and said second section 102 are in continuity with each other and are mutually arranged to form a substantially right angle, i.e. to form a substantially “L”-shaped structure.

As shown in the attached figures, the interface member 11 comprises first connection means M1 to said anchorage structure 2. As it is evident from FIGS. 9 and 16 and as it will be shown in more detail hereinafter in the present description, said first connection means M1 are configured, during use, for maintaining a stable association between said interface member 11 and said anchorage structure 2 and for allowing the mounting of the connector 1 on the anchorage structure 2.

In the shown embodiments, the first connection means M1 comprise a thread at an external surface of said interface member 11 adapted to contact said anchorage structure 2. In particular, said thread is configured for cooperating with a corresponding thread present on the anchorage structure 2 so as to allow the stable association between the interface member 11 of the connector 1 and the anchorage structure 2.

According to the not shown embodiments, the first connection means M1 are configured for associating said connector 1 to said anchorage structure 2 by means of at least among the following coupling types:
shaping coupling;
fitting coupling;
coupling via parts interference.

By way of example, in embodiments other than those shown, the first connection means M1 may comprise one or more protuberances—or teeth—adapted to couple with corresponding seats—or grooves—of the anchorage structure 2 to ensure the stable association between the interface member 11 of the connector 1 and the anchorage structure itself. Alternatively, said first connection means M1 may comprise one or more seats—or grooves—adapted to couple with corresponding protuberances-or teeth-of the anchorage structure 2.

As it is evident from sections of FIGS. 9 and 16, the interface member 11 comprises:
a first seat S1 configured for housing at least a portion of said hollow body 10 comprising said first opening 10′;
a second seat S2 configured for connecting said utility;
a passage P between said first seat S1 and said second seat S2.

In particular, the passage P is configured for putting in fluid communication said first seat S1 and said second seat S2 so as to allow, during use, the fluid flow between said first opening 10′ and said utility. In other words, the passage P is configured for allowing the fluid exchange between the channel 100, the first opening 10′ thereof is housed in said first seat S1, and the utility, which is connected at said second seat S2. The passage P is, therefore, configured for allowing the fluid flow from said hollow body 10 to said utility and/or vice versa.

As shown in the above-mentioned figures, the first seat S1, the passage P and the second seat S2 are in continuity with each other and are substantially coaxially aligned along the entire extension of the interface member 11. Specifically, the first seat S1, the passage P and the second seat S2 are in continuity with each other along the entire extension of the interface member along the rotation axis X.

Preferably, as shown in detail in FIGS. 9 and 16, said hollow body 10 has, on an external surface thereof, an enlargement 103 substantially at said first opening 10′. Said enlargement 103 is configured for being housed in said first seat S1. Specifically, said enlargement 103 represents a portion of the hollow body 10 with an enlarged section with respect to the remaining portion of the hollow body itself, preferably positioned at said first section 101. Said enlargement 103 is intended to be housed in said first seat S1. In other words, at said first section 101, the hollow body 10 has a shoulder adapted to break the extension of the external surface of said first section 101 and generate said enlargement 103. Preferably, said enlargement 103 has on an external surface thereof one or more housing grooves for at least one sealing gasket adapted to adhere to the internal surface of the first seat S1 in order to prevent fluid leakage.

Specifically, the enlargement 103 has a conformation mirroring the one of the first seat S1. Typically, said first seat S1 comprises a cavity of substantially cylindrical or frustoconical form. Consequently, also the enlargement 103 has a substantially cylindrical or truncated conformation mirroring the one of the first seat S1.

As shown, the first seat S1 has at least one riveted end portion 110 towards the rotation axis X in a direction substantially perpendicular to the rotation axis X. Specifically, said riveted end portion 110 is configured for narrowing an access to said first seat S1. As better shown in sections of FIGS. 9 and 16, the riveted end portion 110 of the interface member 11 defines part of said first seat S1 and is, during use, pliable toward the rotation axis X in a direction substantially perpendicular to said rotation axis. Thus, as it will become clearer hereinafter, the access to said first seat S1 is restricted and it is prevented the leakage of said enlargement 103 from said first seat S1.

Specifically, in the shown embodiments, the interface member 11 is associated with said hollow body 10 via parts interference. Said association via parts interference is configured for limiting, preferably preventing, the mutual translation between said hollow body 10 and said interface member 11 along the rotation axis X. In particular, when the enlargement 103 is housed in said first seat S1, this enlargement is blocked within said first seat itself due to the presence of the riveted end portion 110. Specifically, the riveted end portion 110 narrows the access to said first seat S1 so as to prevent the undesired leakage of the enlargement 103, the size of which is greater than the part of access left free by the riveted end portion 110, and therefore the detachment of said hollow body 10 from the interface member 11 is prevented.

In order to realize said association via parts interference, in the manufacturing operations of the connector 1, the hollow body 10 is associated with the interface member 11 by inserting the enlargement 103 inside said first seat S1. Subsequently, the end portion of said first seat S1 undergoes a plastic deformation, in particular a fold towards the rotation axis X, which generates the riveted end portion 110 and causes a narrowing of the access through which the enlargement 103 was housed within the first seat S1. The narrowing of the section of said access is such as to keep the enlargement 103 caged within said seat S1. Thus, an anti-slip coupling is generated between said hollow body 10 and said interface member 11 such that the mutual translation is limited, or substantially prevented, at least along the rotation axis X, whereas freedom of rotation around the rotation axis X itself is maintained. Substantially, a hinge-type mutual constraint is created between hollow body 10 and interface member 11 such that translation is substantially prevented in each direction but freedom of rotation around the rotation axis X is maintained.

In alternative embodiments, which are functionally equivalent and not shown, the hollow body 10 may have, at said first section 101, at least one groove adapted, during use, to be affected by said riveted portion 110 in order to prevent slippage and detachment between said hollow body 10 and said interface member 11.

As it is also shown in the sections of FIGS. 9 and 16, the passage P of the interface member 11 extends in a direction substantially parallel, preferably coinciding, to said rotation axis X. In other words, said passage P is configured as a continuation of said first section 101 of the channel 100 defined by the hollow body 10. Said passage P and said channel 100 are in fluid communication at said first opening 10′, which is, during use, housed in the first seat S1. As previously mentioned, the passage P is configured for putting in fluid communication the first seat S1 and the second seat S2 in order to allow the fluid flow between the utility and the channel 100, and consequently also the duct T1, T2, T connected at the second opening 10″.

As shown in FIG. 2, the passage P has a polygonal section in a plane perpendicular to said rotation axis X. Specifically, said passage P is couplable to an instrument configured for acting on the interface member 11 in order to associate it with said anchorage structure 2. This instrument has a head adapted to couple with said passage P in order to manipulate the interface member 11 so as to allow the coupling thereof with said anchorage structure 2. For example, once said head is inserted into said passage P, the instrument is configured for screwing the interface member 11 so as to couple it with said anchorage structure 2. For example, in the embodiment shown in FIG. 2, said passage P has a hexagonal section in a plane perpendicular to said rotation axis X in order to be affected by a hexagonal wrench or an equivalent tool. For example, once the hexagonal wrench is inserted into said passage P, it is possible to easily screw the interface member 11 and associate the connector 1 with the anchorage structure 2. It is noted that, by virtue of the possibility of free rotation around rotation axis X between hollow body 10 and interface member 11, during the screwing operations of interface member 11, the hollow body 10 remains substantially stable in position. In this perspective, by manipulating and/or screwing the interface member 11, the hollow body 10 is not moved, and in particular is not brought into rotation, keeping substantially in position also the duct T1, T2, T constrained thereto.

As shown for example in FIG. 1, the second seat S2 of the interface member 11 comprises second connection means M2 configured for connecting said connector 1 to said utility. As previously indicated, the utility may be directly connected to the connector 1 at said second connection means M2, as it occurs, for example, with wall-mounted faucets, or an additional duct may be interposed between connector 1 and utility, as in the case of loading and/or unloading ducts of washing machines and dishwashers.

In the embodiments shown in the attached figures, the second connection means M2 comprise a thread at a portion of said second seat S2 adapted to at least partially contact said utility or the additional duct connecting said utility.

In other non-shown embodiments, said second connection means M2 are configured for associating said connector 1 to said utility by means of at least one among the following coupling types:
shaping coupling;
fitting coupling;
coupling via parts interference.

By way of example, said second connection means M2 may comprise one or more protuberances—or teeth—adapted to couple with corresponding seats—or grooves—of the utility, or of the additional connecting duct associated therewith, to ensure the stable association between said interface member 11 and the utility itself. Alternatively, said second connection means M2 may comprise one or more seats—or grooves—adapted to couple with corresponding protuberances—or teeth—of the utility, or of the additional connection duct associated therewith.

As shown in the attached figures, the connector 1 comprises a constraint member 12. This constraint member 12 is associable with the hollow body 10 substantially at the second opening 10″. In particular, the constraint member 12 is associable with the second section 102 of the hollow body 10. The constraint member 12 is configured for constraining said connector 1 and said duct T1, T2, T together, more specifically said duct and said hollow body 10. It is noted that, unlike the association between hollow body 10 and interface member 11, said hollow body 10 and said constraint member 12 are, during use, constrained to each other without substantial freedom of translation and rotation so as to keep the duct T1, T2, T firmly associated to connector 1.

In the shown embodiment, when associated with said hollow body 10, said constraint member 12 defines with said hollow body 10 a housing space 120 for said duct T1, T2, T around said hollow body 10. As evident from sections of FIGS. 9 and 16, the constraint member 12 is fit on said hollow body 10 at a distance therefrom so as to define said housing space 120 for the insertion of said duct T1, T2, T. Specifically, the constraint member 12 is configured for being deformed when said duct T1, T2, T is inserted into said housing space 120 so as to constrain said duct to said connector 1.

It is noted that the typology of constraint between said duct T1, T2, T and connector 1 is advantageously chosen depending on the typology of the duct to be connected. As previously mentioned, typically, said duct T1, T2, T is a multilayer type duct, for example a multilayer M-pipe type duct comprising at least one metal layer enclosed between several polymer layers.

In the shown embodiments, said constraint member 12 is configured for connecting said connector 1 to said duct T1, T2, T by means of a press connection. Specifically, the constraint member 12 is configured as a sleeve fit around said hollow body 10 substantially at said second opening 10″. This typology of connection is particularly adapted to multilayer type ducts comprising at least one metal layer. In fact, once the duct T1, T2, T has been inserted into the housing space 120, the sleeve representing the constraint member 12 is plastically deformed by means of appropriate crimping pliers. In this way, the duct T1, T2, T is compressed between the sleeve and the hollow body 10, which preferably comprises appropriate grooves possibly housing O-ring type gaskets, and a stable constraint between connector 1 and duct T1, T2, T is ensured.

According to other alternative embodiments not shown, the constraint member 12 is configured for connecting the connector 1 to the duct T1, T2, T by means of a screw connection. In these embodiments, the constraint member 12 may simply comprise a hose clamp or a nut and washer system in order to maintain the constraint between hollow body 10 and duct T1, T2, T.

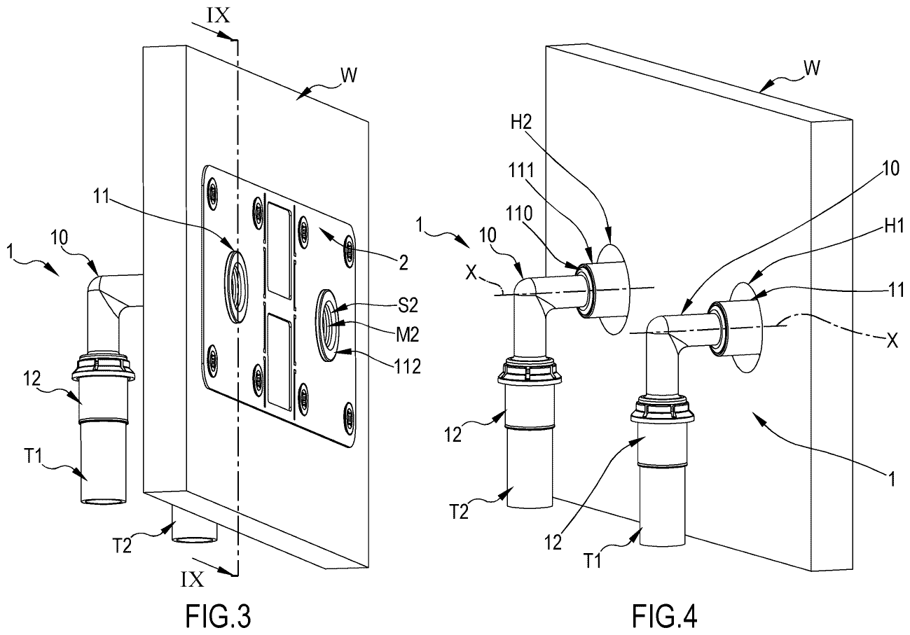

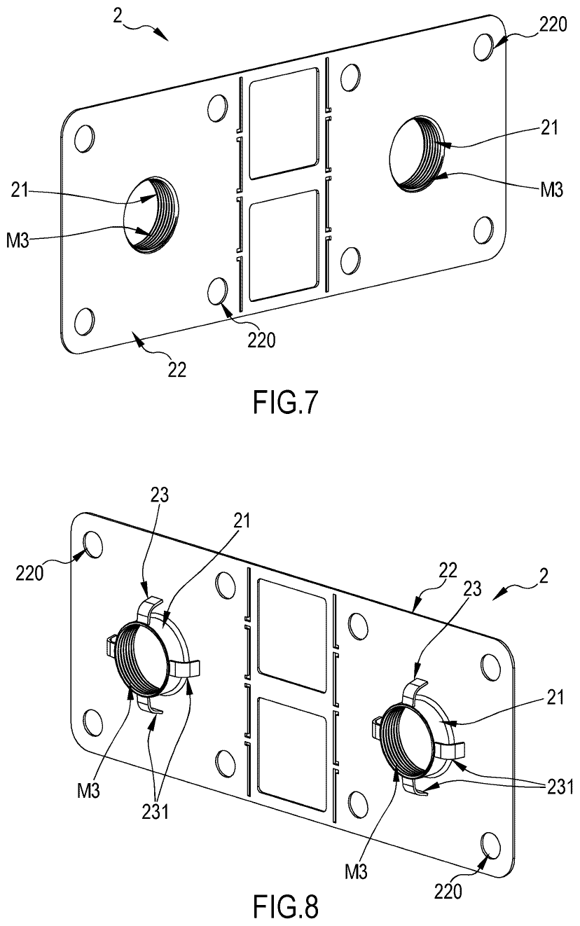

The present description also refers to a fixing system 3 for connecting said duct T1, T2, T to said utility. As shown in FIGS. 3-16, the fixing system 3 comprises:
at least one connector 1 according to what has been previously described;
an anchorage structure 2 for fixing said at least one connector 1 to a wall W.

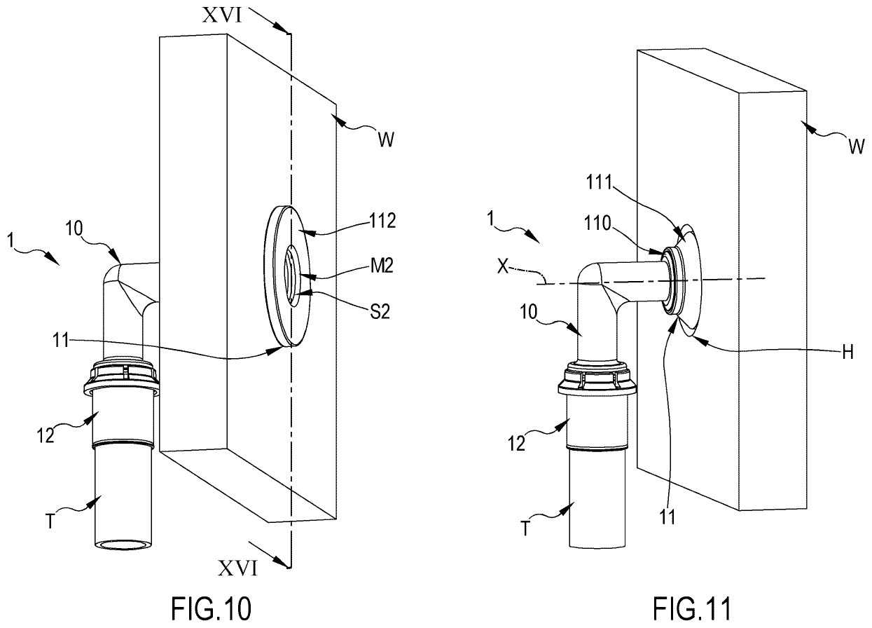

In the attached FIGS. 3-16 are shown two different embodiments of the fixing system 3:
FIGS. 3-9 show a first embodiment of the fixing system 3 comprising two connectors 1 connected to two corresponding ducts T1, T2 and fixed to the wall W by means of a common anchorage structure 2;
FIGS. 10-16 show a second embodiment of the fixing system 3 comprising a connector 1 connected to a corresponding duct T and fixed to the wall W by means of an anchorage structure 2.

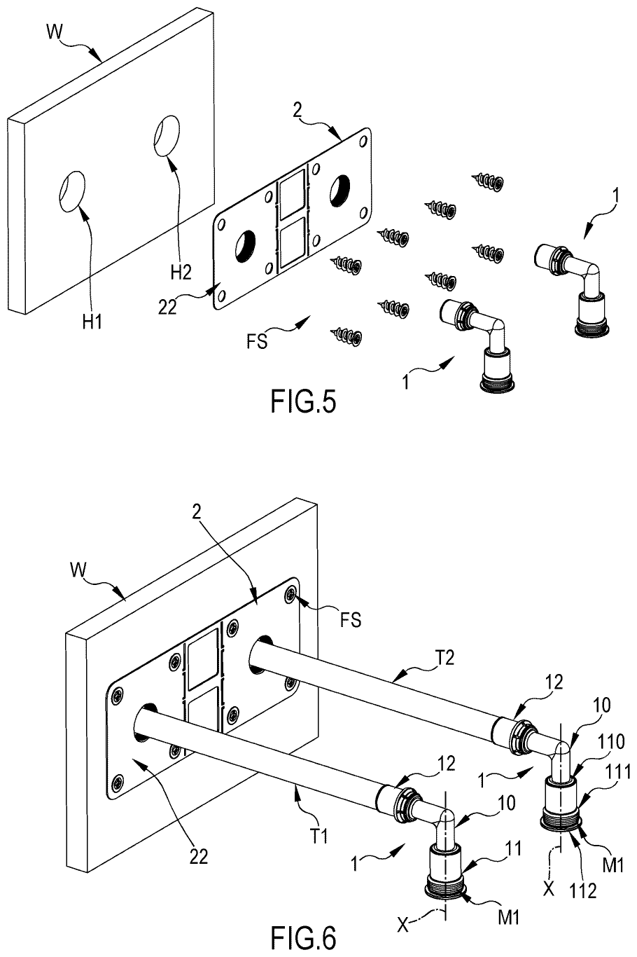

The abovementioned embodiments differ by technical characteristics. These differences represent alternatives of structural and/or functional properties of certain components of the fixing system 3. The technical characteristics of each embodiment, however, are not to be understood as incompatible, if not evident, with the technical characteristics of the other embodiment. In other words, technical characteristics belonging to different embodiments may be adopted in combination without impairing the proper functioning of the fixing system 3. As shown for example in FIGS. 6 and 13, the anchorage structure 2 is configured for being associated with a wall W, e.g. a plasterboard wall or an analogous dividing element, at at least one hole H1, H2, H obtained in the wall itself. Specifically, said at least one hole H1, H2, H is configured as an opening drilled in said wall W in order to extract the duct T1, T2, T, which is housed within a gap of the wall itself.

The at least one connector 1 is, therefore, configured for being connected to said anchorage structure 2. In other words, the anchorage structure 2 represents the means of fixing of the at least one connector 1 to the wall W. Specifically, the at least one connector 1 and the anchorage structure 2 are, during use, connected at said interface member 11, which traverses at least partially said wall W at said at least one hole H1, H2, H. In other words, said interface member 11 is, during use, stably associated with said anchorage structure 2; consequently, the relevant hollow body 10 is free to rotate relatively to interface member 11 around the rotation axis X.

Specifically, with reference to the position assumed in the context of the fixing system 3, the interface member 11 comprises:
a penetration portion 111 extending substantially along said rotation axis X and configured, during use, for at least partially traversing said wall W at said at least one hole H1, H2, H;
an abutment portion 112 in continuity with said penetration portion 111 and configured, during use, for being arranged outside said at least one hole H1, H2, H in contact with said anchorage structure 2 or said wall W.

Specifically, during use, said abutment portion 112 is configured for being positioned externally to said hole H1, H2, H from one side of the wall W facing the utility. On the contrary, the hollow body 10 is arranged, during use, internally to said wall W, i.e., in said gap in which the duct T1, T2, T is housed. In this sense, the abutment portion 112 also represents an end stroke stop for the insertion of said penetration portion 111 within the relevant hole H1, H2, H in the wall W.

Preferably, the abutment portion 112 has a substantially flat extension so that it can be arranged in contact with said wall W or said anchorage structure 2 remaining substantially flush with said wall W/anchorage structure 2 or emerging from said wall W/anchorage structure 2 for a negligible thickness. Specifically, in the shown embodiments, the abutment portion 112 of the interface member substantially has a flat annular form around the second seat S2, more particularly an access of said second seat S2 for connecting the utility.

In the embodiment of FIGS. 3-9, the penetration portion 111 has a substantially cylindrical form. As shown in more detail in the section of FIG. 9, the interface member 11 has a substantially cylindrical conformation ending at one end with the abutment portion 112 and at an opposite end with the riveted end portion 110.

In the embodiment of FIGS. 10-16, the penetration portion 111 has a substantially frustoconical form. As better shown in the section of FIG. 16, the interface member 11 has a substantially frustoconical conformation ending at one end with the abutment portion 112 and at an opposite end with the riveted end portion 110. Specifically, the abutment portion 112 is positioned in continuity with said penetration portion 111 at the portion having the maximum diameter. Similarly, the riveted end portion 110 is positioned in continuity with said penetration portion 111 at the portion having a minimum diameter. Preferably, the abutment portion 112, the penetration portion 111 and the riveted end portion 110 are in continuity with each other and are substantially coaxially aligned along the entire extension of the interface member (along the rotation axis).

For the realization of the connection with said at least one connector 1, the anchorage structure 2 comprises a connection portion 21 for each connector comprised in the fixing system 3. The connection portion 21 is configured, in use, for being arranged in said hole H1, H2, H. The connection portion 21 is further configured for being connected to said interface member 11 in order to associate said anchorage structure 2 and said connector 1. In particular, with reference to sections of FIGS. 9 and 16, said connection portion 21 is configured for being connected to said penetration portion 111 of said interface member 1. In fact, the connection portion 21 of the anchorage structure 2 acts as a plug—or “fischer”—for the fixing to the wall W of said at least one connector 1 by means of the relevant interface member 11. In the mounting operations, in fact, the connection member 21 is first positioned inside the hole H1, H2, H and then the connector 1 is inserted, associating the interface member 11 with the relevant connection portion 21 of the anchorage structure 2.

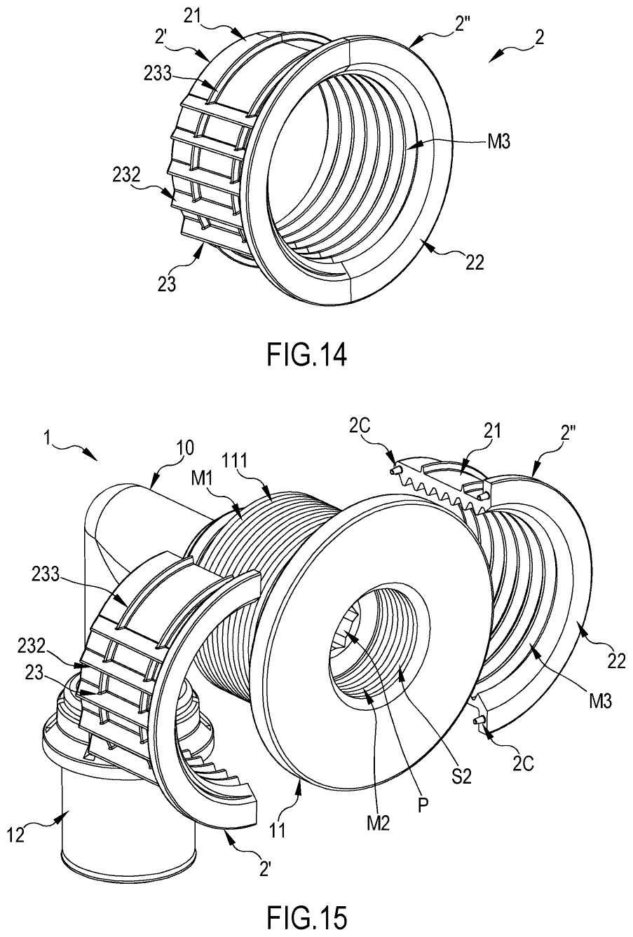

As shown for example in FIGS. 8 and 14, the connection portion 21 has a substantially cylindrical form.

In the embodiment of FIGS. 3-9, the connection portion 21 has a diameter substantially coinciding with the diameter of the penetration portion 111, which, as previously indicated, also has a cylindrical conformation. In this way, the adhesion between penetration portion 111 and connection portion 21 is ensured.

In the embodiment of FIGS. 10-16, the connection portion 21 has a diameter substantially intermediate between the maximum value and the minimum value of the penetration portion 111 so as to allow an easy initial insertion of the interface member 11 and, after the progressive insertion of the penetration portion 111, a deformation of the connection portion 21 adapted to improve the adhesion of the anchorage structure 2 to the wall W. This aspect will become clearer hereinafter in the present description, when further technical characteristics of the fixing system will be introduced.

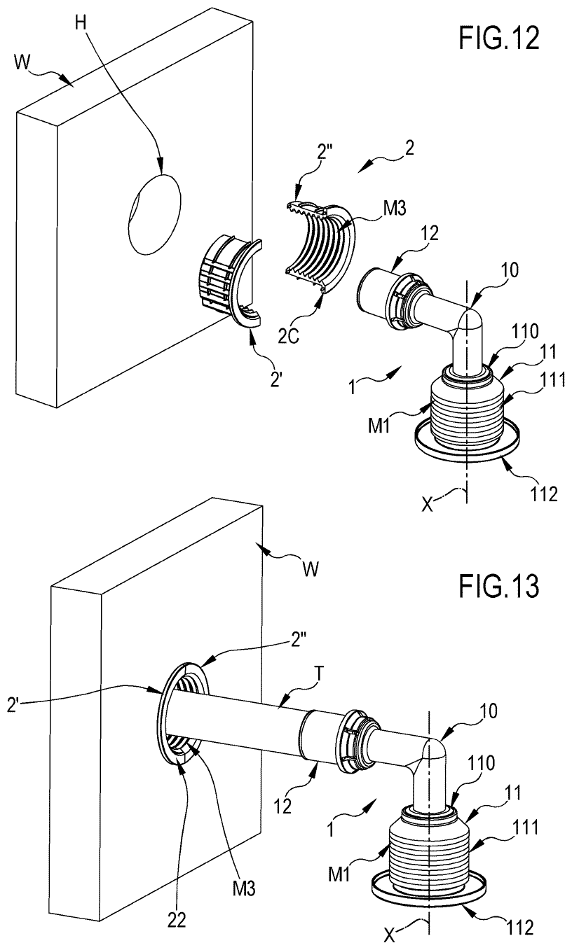

In the same embodiment of FIGS. 10-16, the anchorage structure 2 is a modular structure. According to this embodiment, the anchorage structure 2 comprises at least two modules 2′, 2″ (substantially two halves of the anchorage structure, or half-shells) comprising association means 2C adapted to ensure a mutual association between the modules. Said modules 2′, 2″ are intended to be inserted into said holes H1, H2, H and subsequently spaced out after a deformation caused by the insertion of said interface members 11. In the embodiment shown in particular in FIGS. 12 and 14-15, the anchorage structure 2 comprises two modules 2′ and 2″ connectable by means of association means 2C in the form of pins and corresponding housing cavities.

In other not shown embodiments, said connection portion 21 comprises at least one notch, extended along at least part of a longitudinal extension of said connection portion 21. Said at least one notch is adapted to allow a deformation of the connection portion 21 caused by the insertion of said interface member 11.

As shown in FIGS. 3-16, said connection portion 21 comprises third connection means M3. These third connection means M3 are configured for cooperating with said first connection means M1 of said interface member 11 in order to associate said anchorage structure 2 and said connector 1.

In the shown embodiments, the third connection means M3 comprise at least one thread at an internal surface of said connection portion 21 adapted to contact said interface member 11, specifically the penetration portion 111 thereof. In particular, as shown in sections of FIGS. 9 and 16, the thread of the third connection means M3 is configured for coupling with the relevant thread of the first connection means M1 in order to provide a connection between connection portion 21 and interface member 11 by means of screwing.

According to other alternative and not shown embodiments, said third connection means M3 are configured for cooperating with said first connection means M1 of the interface member 11 in order to realize at least one among the following coupling types:
shaping coupling;
fitting coupling;
coupling via parts interference.

By way of example, said third connection means M3 may comprise one or more protuberances—or teeth—apt to couple with corresponding seats—or grooves—of the first connection means M1 to ensure stable association between the interface member 11 and the anchorage structure 2. Alternatively, said third connection means M3 may comprise one or more seats—or grooves—adapted to couple with corresponding protuberances—or teeth —of the first connection means M1.

It is noted that the connection between the interface member 11 and the anchorage structure 2 does not provide for the use of additional fixing means, such as screws, bolts or nuts. In this sense, the association between connector 1 and anchorage structure 2, and therefore also the installation of the entire fixing system 3, is particularly fast and simplified with respect to the known art solutions in which at least a portion of the connector needed to be fixed to the anchorage structure and/or to the wall by means of additional fixing means.

The anchorage structure 2 comprises a flat portion 22 configured for adhering to said wall W. In particular, the connection portion 21 is protruding from said flat portion 22, which is in fact an end stroke stop for the insertion of said connection portion 21 in the at least one hole H1, H2, H drilled in the wall W.

In the embodiment shown in FIGS. 3-9, the flat portion 22 is constituted by a plate having two faces, one of which is intended to contact the wall W and from which emerge two connection portions 21 intended to be inserted into the holes H1 and H2. It is implied that said holes must be drilled at an opportune distance in order to allow the insertion of both the connection portions. In the aforementioned embodiment, the flat portion 22 in the form of a plate comprises a plurality of seats 220 for housing fixing means FS adapted to constrain the anchorage structure 2 to the wall W. Specifically, said plurality of seats 220 comprises a plurality of passing holes for the insertion of fixing means FS, such as screws, for the constrain of the anchorage structure 2 to the wall W, while keeping the connection portions 21 housed in the respective holes H1 and H2. It is noted that in this embodiment, once the fixing system 3 is installed, the abutment portion 112 of the interface member 11 directly contacts the flat portion 22.

In the embodiment of FIGS. 10-16, the flat portion 22 comprises a lip, extended in continuity with said connection portion 21 in a direction substantially orthogonal to the direction of extension of the connection portion, which, during use, actually coincides with the rotation axis X. Said lip extends throughout the circular extension of the connection portion at an end proximal, during use, to the abutment portion 112 of the interface member 11. As it is evident from the view of FIG. 10 and from the section of FIG. 16, once the fixing system 3 has been installed, the abutment portion 112 is above the flat portion 22, which is in fact enclosed between the wall W and the abutment portion itself and therefore not visible from the outside.

The anchorage structure 2 further comprises at least one stabilization element 23. Said at least one stabilization element 23 is adapted, in use, to contact said wall W, preferably internally to said at least one hole H1, H2, H. In particular, said at least one stabilization element 23 is configured for preventing the accidental detachment of said anchorage structure 2 from said wall W.

In the embodiment of FIGS. 3-9, said at least one stabilization element 23 comprises at least at least one elastically pliable tab 231. Specifically, said at least at one tab 231 advantageously allows to momentarily stabilize the anchorage structure 2 during installation operations, for example before said flat portion 22 is fixed to the wall W by means of said fixing means FS.

In the embodiment shown in FIGS. 10-16, said at least one stabilization element 23 comprises at least one rib 232, 233 emerging from said connection portion 21. Specifically, in the shown embodiment, said stabilization element 23 comprises at least one first rib 232 longitudinally extending along the external surface of the connection portion 21 and at least one second rib 233 transversally extending along the external surface of the connection portion 21. Said ribs 232, 233 allow to stabilize and/or constrain the anchorage structure 2 to the wall W in the installation operations. In fact, in the insertion operations of the connection portion 21 in the hole H, the ribs 232, 233 allow a preventive adhesion of the connection portion 21 to the surface defining the hole H and, subsequently to a plastic deformation caused by the insertion of the interface member 11 in the connection portion 21, a constraint of the anchorage structure 2 to the wall W, for example after a penetration of at least one rib 232, 233 in the internal surface defining the hole H. Referring to the embodiment of FIGS. 10-16, it is noted again that the penetration portion 111 has a frustoconical form and the connection portion 21 has a cylindrical form with a diameter intermediate between the maximum diameter and the minimum diameter of the penetration portion. In this embodiment, the association between interface member 11 and connection portion 21 is realized by first inserting the penetration portion 111 at the minimum diameter sector. The progressive insertion causes the contact between the external surface of the penetration portion 111 and the internal surface of the connection portion 21 until the diameter of the penetration portion 111 is such as to cause a deformation of the connection portion 21 and the consequent introduction of the ribs 232, 233 into the surfaces of the wall W defining the hole H.

The salient steps of an installation method of the fixing system 3 shown above are now indicated. For the sake of simplicity, reference will be made to a fixing system 3 for the connection of a single duct T to a utility, as shown for example in the embodiment of FIGS. 10-16. The matter hereinafter disclosed may be trivially extended to embodiments similar to those shown in FIGS. 3-9, i.e., embodiments in which the fixing system 3 comprises several connectors 1 for connecting as many ducts to one or more utilities. This installation method comprises at least the following steps:
arranging a fixing system 3 according to what has been previously described;
extracting the duct T from a hole H drilled in the wall W;
positioning the anchorage structure 2 at said hole H;
constraining the duct T to the corresponding connector 1 at the second opening 10″ of the hollow body 10;
associating the connector 1 to said anchorage structure 2 by inserting said connector frontally with said anchorage structure.

It is noted that the above indicated steps do not need to be performed in the order of exposition. The above represents the typical installation sequence also followed for the installation of known fixing systems. However, depending on the different characteristics comprised in the different embodiments, some steps may be advanced or postponed from the above.

In addition, it is noted that when said anchorage structure is a modular structure comprising two or more modules, it is possible to perform the step of constraining the at least one duct to the corresponding connector without necessarily passing the at least one duct through the anchorage structure. In fact, classical anchorage structures have at least one perforated plate that must be passed through the duct before providing for constraining the duct to the connector. Should the duct be fixed to the connector before the positioning of the plate, it would be impossible to provide for a proper installation of the fixing system.

Some aspects of the steps of the installation method of the fixing system 3 are now described in more detail. The step of extracting the duct T provides that said duct T, initially housed in the gap of said wall W, traverses the hole H in order to be manipulated and subsequently associated to the relevant connector 1. In this sense, where said hole H is not already present in said wall W, the installation method preferably comprises a preventive step of drilling the hole H in the wall W. This preventive step provides for making in said wall W at least one through hole connecting the gap in which the duct T is housed with the environment in which the utility to be served by said duct is to be located. Typically, said hole H has a circular section and has a sufficient diameter to allow both the passage of said duct T and the housing of the connection portion 21 of the anchorage structure 2 and of the interface member 11 of the connector 1, in particular of the penetration portion 111 thereof. It is important that the hole H is opportunely sized to allow, on the one hand, the housing of the various components of the fixing system 3 and, on the other hand, an effective grip of the anchorage structure 2 which prevents the risk of accidental detachment of the fixing system 3 from the wall W. In the embodiments in which several ducts T1, T2 must be connected, the anchorage structure 2 has several connection portions 21. It is essential that the holes H1, H2 drilled in the wall W are opportunely spaced so that connection portions 21 can be correctly inserted into the relevant holes H1, H2.

The next step of positioning the anchorage structure 2 at said hole H provides for housing at least partially the connection portion 21 in the corresponding hole H. In the embodiments in which the anchorage structure 2 does not have a modular structure, it is essential that the duct T is passed through the relevant connection portion 21 before it is constrained to the relevant connector 1, otherwise the installation method cannot be completed. On the contrary, if the anchorage structure 2 has a modular structure, said step of positioning the anchorage structure 2 at said one hole H can be carried out after other operations, in particular before the step of constraining said duct T to the corresponding connector 1 at the second opening 10″ of the hollow body 10. In embodiments in which the anchorage structure 2 has a plurality of seats 220 on the flat portion 22, the step of positioning the anchorage structure 2 provides for fixing the anchorage structure itself to the wall W by means of constraining means FS, such as screws.

The step of constraining said duct T to the corresponding connector 1 provides for fixing the duct to the hollow body 10 of the relevant connector at the second opening 10″ in order to put the channel 100 in communication with the duct T. Preferably, said step of constraining the duct to the corresponding connector provides for inserting the duct T into the relevant housing space 120 defined between the hollow body 10 and the constraint member 120. Subsequently, the duct T is associated to the hollow body 10 by means of a press connection or a screw connection, depending on the embodiment of the constraint member 12.

The step of associating the connector 1 with the anchorage structure 2 provides for inserting the penetration portion 111 of the interface member 11 in the connection portion 21 of the anchorage structure 2, which preferably is already housed in said hole H. The cooperation between the first connection means M1 and the third connection means M3 allows a stable association between the anchorage structure 2 and the interface member 11, and thus the connector 1. In this way, the interface member 11 is stably connected to the anchorage structure 2 whereas the hollow body 10 is free to rotate around the rotation axis X on the side of the wall W facing the housing gap of the duct T. Preferably, the step of associating the connector 1 to said anchorage structure 2 provides for a screwing of said interface member 11. In particular, when said first connection means M1 and said third connection means M3 comprise threads, the screwing of the interface member 11 allows the progressive insertion of the penetration portion 111 in the connection portion 21 and the constraint between connector 1 and anchorage structure 2. It is also noted that, by virtue of the freedom of rotation between hollow body 10 and interface member 11, the rotation of the latter does not involve the rotation of the entire connector 1 and the duct T is not put into rotation. In this way, during the operations of association of the connector 1 to the anchorage structure 2, the relevant duct T is stationed in a position that minimizes stresses to which it is subjected and breakings, bottlenecks, and malfunctions due to undesired bending of the duct itself are prevented.

It is also noted that the step of associating connector 1 to the anchorage structure 2 does not provide for the use of fixing means, such as screws. In fact, the anchorage structure 2 and the connector 1 are constrained to each other by means of the cooperation of the first means of connection M1 present on the interface member 11 and the third means of connection M3 typically present at the connection portion 21. In this perspective, the fixing of the connector 1 to the anchorage structure 2 is particularly facilitated.

Preferably, once the fixing system 3 is installed, the installation method comprises a final step of connecting said connector 1 to said utility at second connection means M2 of the second seat S2 of the interface member 11. It is noted that the utility may be directly connected to said connector 1 at said second seat S2 or the utility may be indirectly connected to said connector 1, for example by means of another hose connecting the utility to the interface member 11.

### Advantages of the Invention

The so conceived invention is susceptible of various modifications and variants, all in the field of the inventive concept, and the mentioned components are replaceable by other technically equivalent elements.

The invention has significant technical effects and achieves important advantages. Firstly, as it is evident from the above indicated description, the invention allows to overcome the drawbacks of the known technique. Firstly, the possibility of free rotation between hollow body 10 and interface member 11 allows an optimal coupling with any arrangement of the duct T1, T2, T in the gap in the wall W in which it is housed. In particular, the connector 1 according to the present invention allows to minimize the stress to which the duct T1, T2, T is subjected, by eliminating the stresses to which both the connector 1 and the duct T1, T2, T are subjected due to a sub-optimal mutual positioning. In fact, the known solutions provide for a connector that is a single body or whose components are, in use, integral with each other and these solutions provide for a limited number of mutual placements, possibly only one, in the fixing of the connector to the anchorage structure. In this sense, the known solutions only incidentally allow a configuration of the fixing system that minimizes the stresses to which the duct for circulating a fluid and the connector are subjected. Typically, the duct for circulating is at least partially bent and the connector is subjected to stresses caused by the tendency of the duct to return to a condition that minimizes internal stresses. Thus, known fixing systems are almost always found to operate under suboptimal conditions that, in the long term, can lead to malfunctioning, or even damages, leakages and breakings. On the contrary, in the context of the fixing system 3 of the present invention, the hollow body 10 and the interface member 11 are freely rotatable around the rotation axis X and thus a substantially infinite plurality of mutual positionings of the hollow body 10 with respect to the interface member 11 are possible. Consequently, the element of contact with the duct T1, T2, T—i.e. the hollow body 10—and the element of contact with the anchorage structure 2—i.e. the interface member 11—are free to mutually position themselves in a condition which minimizes the stresses to which the duct T1, T2, T is subjected, and therefore also the connector 1, improving the stability of the connection of the latter with the relevant anchorage structure 2. In this perspective, the connector 1 according to the present invention is extremely solid, durable and positively influences the reliability of the fixing system 3 in which it is used. The free rotation between the hollow body 10 and the interface member 11 allows also to simplify the installation operations of the fixing system 3, and in particular the insertion operations of the connector 1 with the relevant duct T1, T2, T inside the hole H1, H2, H, avoiding complicated manipulations to avoid excessive bending of the duct itself.

Secondly, the fixing system 3 according to the present invention allows an easy and quick association of the connector 1 to the anchorage structure 2. In particular, not being necessary other fixing means for fixing the connector 1 to the anchorage structure 2, it is uniquely necessary to insert the interface member 11 of the connector 1 in the connection portion 21 of the anchorage structure 2 and to couple, for example by means of screwing, the first connection means M1 with the third connection means M3. It is noted that when the association between the connector 1 and the anchorage structure 2 provides for the screwing of the interface member 11, the hollow body 10 during the steps of mounting does not integrally rotate with it and, advantageously, the duct T1, T2, T (even if already constrained to the hollow body of the connector) remains substantially stable in the position of minimum stress. If, instead, the connector is a unique body (as in the known art), the screwing thereof to the anchorage portion could put in rotation the duct in the gap, with subsequent breaking risks of the connector and/or of the duct itself further than exposing to a breaking risk other elements present in the gap of the wall after the impact with the rotating duct.

Then, the present invention, because of the possibility of free rotation around the rotation axis X between the hollow body 10 and the interface member 11, reaches a double purpose. On one hand, the present invention allows a minimization of the internal stresses to which both the connector 1 and the duct T1, T2, T are subjected increasing significantly the solidity and reliability of the whole fixing system 3. On the other hand, it significantly simplifies and speeds up the operations of installation of the fixing system 3, which first of all does not need other fixing means excluding the one possibly necessary for the fixing of the anchorage structure 2 to the wall. Furthermore, it is noted that the connector 1 is frontally associated to the anchorage structure 2 (by inserting it frontally in the anchorage structure and not behind as it occurs in the known art), making the installation operations particularly easy to carry out.

The connector and the fixing system of the present invention are easily adaptable to different devices of utilities and to different installation conditions, resulting then provided with a greater versatility.

Another advantage of the connector and of the system according to the present invention is given by the possibility to be realized and mounted in an easy and quick way.

Furthermore, the connector and the system according to the present invention are characterized by an easy and rational structure and functioning.

The connector for connecting, the fixing system and the installation method according to the present invention constitute alternative and original solutions, with respect to the known art, for connecting a duct for circulating a fluid to a utility.

1. Connector (1) for connecting a duct (T1, T2, T) for circulating a fluid to a utility, said connector (1) comprising:
a hollow body (10) defining a channel (100) for the passage of said fluid between a first opening (10′) and at least one second opening (10″), said hollow body (10) being configured for being constrained to said duct (T1, T2, T) at said at least one second opening (10″); and
an interface member (11) associated with said hollow body (10) substantially at said first opening (10′), said interface member (11) being configured for associating said connector (1) to an anchorage structure (2), said interface member (11) also being configured for connecting said connector (1) to said utility and for allowing a fluid communication between said channel (100) of the hollow body (10) and said utility;
wherein said hollow body (10) and said interface member (11) are, during use, freely rotating in a reciprocating manner around a rotation axis (X).

2 The connector (1) according to claim 1, wherein said hollow body (10) comprises a first section (101) extended from said first opening (10′) along said rotation axis (X) and at least one second section (102) extended from said at least one second opening (10″), said at least one second section (102) extended along a direction not parallel to said rotation axis (X);
and/or wherein said hollow body (10) comprises a single second opening (10″);
and/or wherein said connector (1) is an elbow connector and said at least one second section (102) is extended in a direction substantially orthogonal to said rotation axis (X).

3. The connector (1) according to claim 1 or 2, wherein said interface member (11) comprises first connection means (M1) for the association with said anchorage structure (2);
and/or wherein said first connection means (M1) comprise a thread at an external surface of said interface member (11) adapted to contact said anchorage structure (2);
and/or wherein said first connection means (M1) are configured for associating said connector (1) to said anchorage structure (2) by means of at least one from among the following coupling types: shaping coupling, fitting coupling, coupling via parts interference.

4. The connector (1) according to any one of the preceding claims, wherein said interface member (11) comprises:
a first seat (S1) configured for housing at least one portion of said hollow body (10) comprising said first opening (10′);
a second seat (S2), configured for connecting said utility;
a passage (P) between said first seat (S1) and said second seat (S2), said passage (P) being configured, during use, for placing in fluid communication said first opening (10′) and said utility;
and/or wherein said hollow body (10) has, on an external surface thereof, an enlargement (103) substantially at said first opening (10′), said enlargement (103) being housed in said first seat (S1);
and/or wherein said interface member (11) has, at said first seat (S1), at least one riveted end portion (110) towards the rotation axis (X) and substantially perpendicular to said rotation axis (X), said riveted end portion (110) being configured for narrowing an access to said first seat (S1);
and/or wherein said interface member (11) is associated with said hollow body (10) via parts interference in order to limit, preferably prevent, a mutual translation between said hollow body (10) and said interface member (11) along the rotation axis (X).

5. The connector (1) according to the preceding claim, wherein said passage (P) is extended in a direction substantially parallel, preferably coinciding, with said rotation axis (X);
and/or said passage (P) has, at least partially, a polygonal section in a plane perpendicular to said rotation axis (X), said passage (P) being couplable to an instrument configured for acting on the interface member (11) in order to associate it with said anchorage structure (2);
and/or wherein said passage (P) has hexagonal section in a plane perpendicular to said rotation axis (X).

6. The connector (1) according to claim 4 or 5, wherein said second seat (S2) comprises second connection means (M2) configured for connecting said utility to said connector (1);
and/or wherein said second connection means (M2) comprise a thread at a portion of said second seat (S2) adapted to at least partially contact said utility;
and/or wherein said second connection means (M2) are configured for associating said connector (1) with said utility by means of at least one from among the following coupling types: shaping coupling, fitting coupling, coupling via parts interference.

7. The connector (1) according to any one of the preceding claims comprising a constraint member (12) associable with said hollow body (10) substantially at said second opening (10″), said constraint member (12) being configured for constraining said connector (1) and said duct (T1, T2, T) together;
and/or wherein, when associated with said hollow body (10), said constraint member (12) defines with said hollow body (10) a space (120) for housing said duct (T1, T2, T) around said hollow body (10);
and/or wherein said constraint member (12) is configured for constraining said connector (1) and said duct (T1, T2, T) by means of a pressing connection;
and/or wherein said constraint member (12) is configured for constraining said connector (1) and said duct (T1, T2, T) by means of a tightening connection.

8. Fixing system (3) for connecting a duct (T1, T2, T) for circulating a fluid to a utility comprising:
at least one connector (1) according to claim 1; and
an anchorage structure (2) configured for being associated with a wall (W), for example a plasterboard wall or an analogous dividing element, at at least one hole (H1, H2, H) in the wall (W) itself, said anchorage structure (2) being configured for being connected to said at least one connector (1);
said at least one connector (1) and said anchorage structure (2) being, during use, connected at said interface member (11), said interface member (11) at least partially traversing said wall (W) at said at least one hole (H1, H2, H).

9. The fixing system (3) according to claim 8, wherein said interface member (11) comprises:
a penetration portion (111) and configured, during use, for at least partially traversing said wall (W) at said at least one hole (H1, H2, H); and
an abutment portion (112) in axial continuity with said penetration portion (111) and configured, during, for being arranged outside said at least one hole (H1, H2, H) and in contact with said anchorage structure (2) or said wall (W);
and/or wherein said penetration portion (111) is extended substantially along said rotation axis (X);
and/or wherein said penetration portion (111) has a substantially cylindrical form;
and/or wherein said penetration portion (111) has a substantially frustoconical form and/or wherein said abutment portion (112) has a substantially flat extension.

10. The fixing system (3) according to claim 8, wherein said anchorage structure (2) comprises a connection portion (21) for each connector (1), said connection portion (21) being configured, during use, for being arranged in said at least one hole (H1, H2, H) and for being connected to said interface member (11) in order to associate said anchorage structure (2) and said connector (1) with each other;
and/or wherein said connection portion (21) has substantially cylindrical form;
and/or wherein said anchorage structure (2) is a modular structure comprising at least two modules (2′, 2″) provided with association means (2C) for a mutual association;
and/or wherein said connection portion (21) comprises at least one notch, extended along at least part of a longitudinal extension of said connection portion (21).

11. The fixing system (3) according to claim 8,
wherein said interface member (11) comprises first connection means (M1) for the association with said anchorage structure (2);
and/or wherein said first connection means (M1) comprise a thread at an external surface of said interface member (11) adapted to contact said anchorage structure (2);
and/or wherein said first connection means (M1) are configured for associating said connector (1) to said anchorage structure (2) by means of at least one from among the following coupling types: shaping coupling, fitting coupling, coupling via parts interface; and
wherein said connection portion (21) comprises third connection means (M3) configured for cooperating with said first connection means (M1) of the interface member (11) in order to associate said anchorage structure (2) and said connector (1);
and/or wherein said third connection means (M3) comprise at least one thread at an internal surface of said connection portion (21) adapted to contact said interface member (11);
and/or wherein said third connection means (M3) are configured for cooperating with said first connection means (M1) of the interface member (11) in order to make at least one from among the following coupling types: shaping coupling, fitting coupling, coupling via parts interference.

12. The fixing system (3) according to claim 8, wherein said anchorage structure (2) comprises a flat portion (22) configured for adhering to said wall (W), said connection portion (21) being protruding from said flat portion (22);
and/or wherein said flat portion (22) comprises a plurality of seats (220) for housing fixing means (FS) adapted to constrain the anchorage structure (2) to the wall (W).

13. The fixing system (3) according to claim 8, wherein said anchorage structure (2) comprises at least one stabilization element (23) adapted, during use, to contact said wall (W) and configured for preventing the detachment of said anchorage structure (2) from said wall (W);
and/or wherein said at least one stabilization element (23) comprises at least one elastically pliable tab (231);
and/or wherein said at least one stabilization element (23) comprises at least one rib (232, 233) emerging from said connection portion.

14. Method for installing a fixing system (3) for connecting at least one duct (T1, T2, T) for circulating a fluid to a utility comprising at least the following steps:
arranging the fixing system (3) in accordance with claim 8;
extracting said at least one duct (T1, T2, T) from at least one hole (H1, H2, H) made in the wall (W);
positioning said anchorage structure (2) at said at least one hole (H1, H2, H);
constraining said at least one duct (T1, T2, T) with the corresponding connector (1) at said second opening (10″) of the hollow body (10);
associating each connector (1) with said anchorage structure (2) by inserting each connector (1) frontally with respect to said anchorage structure (2).

15. Installation method according to claim 14 comprising a step of connecting said connector (1) to said utility;
and/or wherein said step of associating said connector (1) with said anchorage structure (2) provides for screwing said interface member (11);
and/or wherein said step of associating said connector (1) with said anchorage structure (2) does not provide for a use of further means for fixing the connector (1) to the anchorage structure (2).
